(19) United States
(12) Patent Application Publication
(10) Pub. No.: US 2004/0215797 A1
(43) Pub. Date: Oct. 28, 2004

(54) Creating and analyzing an identifier indicating whether data is in an expected form

(75) Inventor: Marc J. Hadley, Brookline, NH (US)

Correspondence Address: Finnegan, Henderson, Farabow,, Garrett & Dunner, L.L.P., 1300 I Street, N.W., Washington, DC, 20005-3315, US

(73) Assignee: Sun Microsystems, Inc.

(21) Appl. No.: 10/630,846

(22) Filed: Jul. 31, 2003

Related U.S. Application Data
(60) Provisional application No. 60/465,899, filed on Apr. 28, 2003.

(51) Int. Cl. G06F 15/16

(52) U.S. Cl. 709/230

(57) ABSTRACT

Communicating a data element in a way that does not identify the format of the element comprises creating an identifier specifying the format of the data element, inserting the identifier as part of the data element, and transmitting the data element and identifier. In addition communicating a data element in a way that does not identify the format of the element may include receiving the data element, extracting a separate identifier that specifies the format of the data element, and processing the data using the identifier.

### RELATED APPLICATIONS

Under provisions of 35 U.S.C. § 119(e), Applicant claims the benefit of U.S. provisional application No. 60/465,899, filed Apr. 28, 2003, which is incorporated herein by reference.

### TECHNICAL FIELD

The present invention relates to the field of sending and receiving data over a network. More particularly, the present invention relates to creation and analysis of data sent over a network.

### BACKGROUND INFORMATION

Data sent through a network may comprise an Internet web page, for example, written in Hypertext Markup Language (HTML). The data in HTML format may be used by a program, referred to as a web browser that displays the web page described in the data. HTML uses tags (codes) embedded in the data that may define the page layout, fonts, and graphic elements as well as the hypertext links to other documents on the Internet.

As an alternative to HTML, extensible markup language (XML) may be used. XML uses a similar tag structure as HTML, however, whereas HTML defines how the elements are displayed, XML defines what the elements contain. While, HTML uses predefined tags, XML allows the tags to be defined by the developer of the page. Thus, virtually any data items, for example, a product, a sales rep, or an amount due, can be identified, allowing web pages to function like database records. By providing a common method for identifying data, XML may support business-to-business transactions and may become an important format for electronic data interchange.

In order to perform this self-defining function, XML includes meta-data (data that describes other data), in the form of an XML schema that defines XML tags. The schema may define the content type as well as name, but specifies neither semantics nor a tag set. In other words, XML provides meta-data to define tags and the structural relationships between them. Since there is no predefined tag set, XML does not include any preconceived semantics.

As an alternative to XML, abstract syntax notation 1 (ASN.1), an international standard for classifying data structures, may be used for communicating over a network. Within ASN. 1, there are 27 data types with tag values starting with 1, for example: Boolean (1); integer (2); and bit string (3). ASN.1 is widely used in ground and cellular telecommunications as well as aviation. Furthermore, ASN.1 uses additional rules to lay out the physical data, the primary set being the basic encoding rules (BERs). Additional rules include, distinguished encoding rules (DER), used for encrypted applications, canonical encoding rules (CER), a DER derivative that is not widely used, and packed encoding rules (PER), that result in the fewest number of bytes.

### SUMMARY OF THE INVENTION

Consistent with the present invention, a method for communicating a data element in a way that does not identify the format of the element comprises creating an identifier specifying the format of the data element, inserting the identifier as part of the data element, and transmitting the data element and identifier.

In another aspect, a method for communicating a data element in a way that does not identify the format of the element comprises receiving the data element, extracting a separate identifier that specifies the format of the data element, and processing the data using the identifier.

Both the foregoing summary and the following detailed description are merely exemplary. They do not limit the scope of the invention which the attached claims delineate.

### BRIEF DESCRIPTION OF THE DRAWINGS

The accompanying drawings show exemplary embodiments of the claimed invention. In the drawings:

FIG. 1 is a functional block diagram of a system for communicating over a network consistent with the present invention;

FIG. 2 is a flow chart of a method for communicating over a network consistent with the present invention; and

FIG. 3 is a flow chart of a subroutine used in the method of FIG. 2 for creating a unique identifier.

### DETAILED DESCRIPTION

Reference will now be made to various embodiments consistent with this invention, examples of which are shown in the accompanying drawings and will be obvious from the description of the invention. In the drawings, the same reference numbers represent the same or similar elements in the different drawings unless specified otherwise.

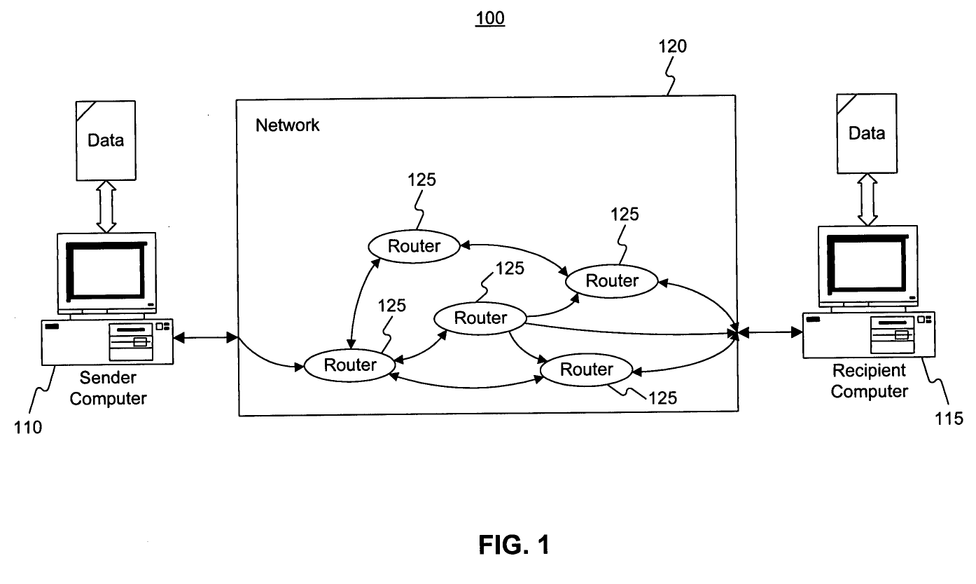

FIG. 1 shows a system 100 for communicating over a network consistent with this invention. System 100 includes a sender computer 110, a recipient computer 115, and a network 120. Either sender computer 110, recipient computer 115 can contain a component for creating a unique identifier and a component for sending the data element through the network.

Sender computer 110 or recipient computer 115 may include a personal computer or other similar microcomputer-based workstation or any type of computer operating environment such as hand-held devices, multiprocessor systems, microprocessor-based or programmable consumer electronics, minicomputers, mainframe computers, and the like. Sender computer 110 or recipient computer 115 may also be actual or virtual systems in distributed computing environments where tasks are performed by remote processing devices, or may include a mobile terminal such as a smart phone, a cellular telephone, a cellular telephone utilizing wireless application protocol (WAP), personal digital assistant (PDA), intelligent pager, portable computer, a hand held computer, a conventional telephone, or a facsimile machine. The precise structure of sender computer 110 or recipient computer 115 is not critical.

The location and operator of sender computer 110 and recipient computer 115 are also not critical. Either may be located, for example, in a home, office, store, a store counter, or a retail center kiosk, and either may be operated by a consumer, a technician, an advisor, a sales consultant, a sales person, or any other person.

Network 120 may comprise, for example, a local area network (LAN) or a wide area network (WAN). Such networking environments are commonplace in offices, enterprise-wide computer networks, intranets, and the Internet. When a LAN is used as network 120, sender computer 110 or recipient computer 115 may be connected to network 120 through a network interface located at sender computer 110 and recipient computer 115. When a WAN networking environment, such as the Internet, is used as network 120, sender computer 110 and recipient computer 115 typically include an internal or external modem (not shown) or other means for establishing communications over the WAN.

In addition to a wire-line communications system, network 120 can include a wireless communications system or a combination of wire-line and wireless systems, may be utilized as network 120. Wireless systems can include radio transmission (cellular, microwave, satellite, packet radio, and spread spectrum radio), infrared line of sight, or any other type of wireless communication.

Network 120 may comprise, but is not limited to, the Internet. Basically, the Internet is an association of networks including millions of computers across the world that all work together to share information. On the Internet, the main lines that carry the bulk of the traffic and are collectively called the Internet backbone. The Internet backbone is formed by the biggest networks in the system, owned by major Internet service providers (ISPs). By being connected together, these networks create a fast data pipeline that crosses the United States and extends to Europe, Japan, Asia, and the rest of the world.

In the United States, there are five points where main lines comprising the Internet backbone intersect. These intersections are called network access points (NAPs) and are located in San Francisco, San Jose (California), Chicago, New York, Pennsauken, New Jersey, and Washington, D.C. Located at the NAPs is high-speed networking equipment used to connect the Internet backbone to additional networks. These additional networks may be owned by smaller regional and local ISPs, which in turn may lease access to enterprises or persons in the areas they serve.

In exchanging information over the Internet, computers connected to the Internet may use a network protocol called transmission control protocol (TCP) and Internet protocol (IP), collectively referred to as “TCP/IP”. In general, TCP/IP creates a network, known as a “packet-switched network” intended to minimize the chance of losing any data that is sent over the network. In doing so, TCP is used to break down the data to be sent over the network into small pieces called “packets” and wraps each packet in an electronic envelope with an address of both sender computer 110 and recipient computer 115, for example. Next in exchanging over the Internet, IP is used to determine how the data should move from sender computer 110 to recipient computer 115 by passing through a series of routers 125 located in network 120. Each router 125 examines a packet's address and then passes it to another router 125 in network 120 until the packet converges on recipient computer 115. Once recipient computer 115 has received all the packets, TCP is used at recipient computer 115 to reassemble them into the data.

Sending and receiving data over a network may be referred to as “serializing” and “deserializing” respectively. Unlike one standard for of exchanging data, XML, ASN.1 PER includes very little metadata when serialized, which allows data to be transmitted more quickly. Deserializing ASN.1 PER data, however, may require access to the data description or schema used in serializing the data. If the schema used during deserialization does not exactly match the schema for serializing, then the transmission may be compromised. For example, if a deserializer expects a string at a particular position in the data, but an integer is present, then the deserializer may experience problems. Such differences may occur in network communication systems where different software versions are used on either side of a communication channel. When different software versions are used, either side of the communication channel may use a different schema and therefore may have different expectations for the data transmitted. In this case, the data may not be properly communicated.

To provide a reliable failure mode when communicating parties use different schema without sacrificing the speed advantage of ASN.1 PER, systems and methods consistent with the present invention may communicate the schema being used for a given ASN.1 PER message. Such systems and methods include a unique identifier for a given data structure that may depend on the actual structure of the data being communicated. This is much different, for example, than merely including an XML QName of a data type at least because the contents may be silently modified by a software developer

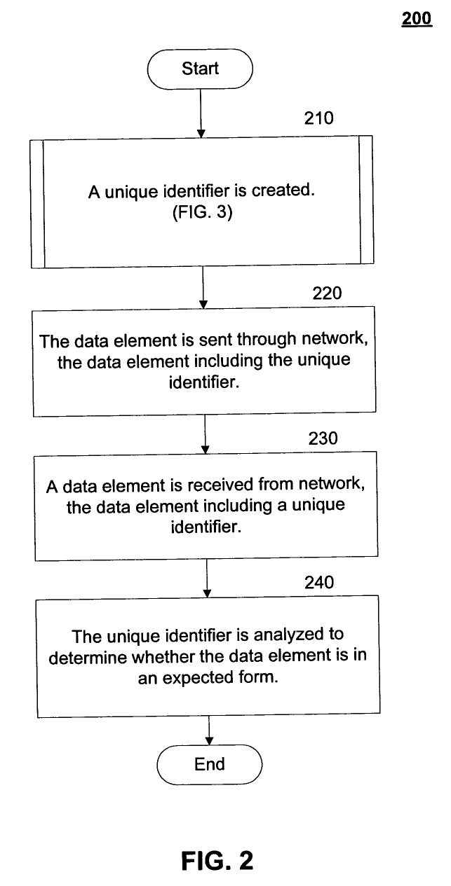

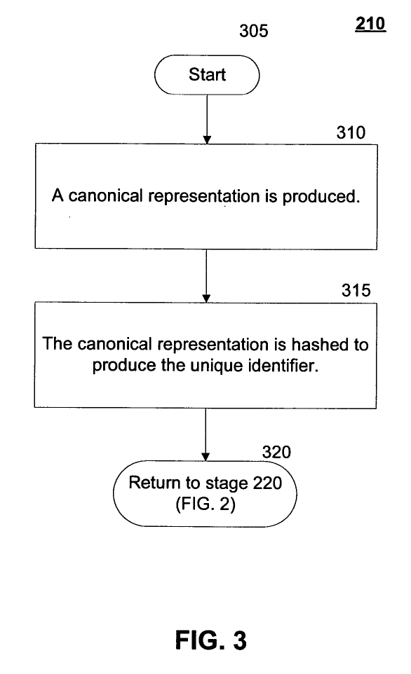

FIG. 2 is a flow chart setting forth the general stages involved in exemplary method 200 for communicating over a network. The implementation of the stages of method 200 will be described in greater detail in FIG. 3. As the method starts, a unique identifier is created (stage 210) to indicate the form of the data element actually serialized. For example, sender computer 110 can compute the unique identifier from the schema it used to serialize the data. Creating the unique identifier is shown in greater detail with respect to FIG. 3.

Next, a data element with the identifier is sent through network 120 (stage 220). For example, all data transmissions sent through network 120 may be wrapped in a well-known envelope format. The envelope may associate the unique identifier with the data element. For example, the data may be sent from sender computer 110 through the routers 125 of network 120 (FIG. 1).

Recipient computer 115 (FIG. 1), or some other device, then receives the data element with the identifier from network 120 (step 230), and the unique identifier is analyzed to determine whether the data element is in an expected form (step 240). As stated above, the data may be wrapped in a well-known envelope format. The unique identifier may be positioned in the same place in the envelope and of a consistent size. The unique identifier may indicate whether the data is in an expected form, but may not indicate what the expected form should be. As indicated above, the unique identifier may result from a one-way transformation of the data format/schema. Sender computer 110 may compute the unique identifier from the schema it used to serialize the data. Upon receiving the data element, recipient computer 115 may compute a second identifier from the schema it intends to use to deserialize the data element. Next, recipient computer 115 compares the unique identifier with the second identifier. If the unique identifier and the second identifier do not match, then deserialization may fail.

During analysis, for example, systems and methods consistent with the present invention may not reject data during deserialization if, for example, the ASN.1 PER serialized form of data does not change. For example, such systems and methods may ignore changes in the element name of a web services description language (a protocol for a web service that describes its capabilities, that retain the element type.) Similarly, the systems and methods may also ignore modifications to an XML schema type definition that does not result in a change to the ASN.1 PER encoding of an XML message. For example, consistent with the invention, a receiving system does not have to know the format. The receiving system may only know the format with respect to the ASN.1 data types serialized. For example, if firstname, lastname are sent as two strings, then it does not matter if a receiving system calls them forename and surname provided they are represented as strings.

FIG. 3 is a flowchart of an exemplary subroutine in stage 210 (FIG. 2) for creating a unique identifier to indicate whether a data element is in an expected form. First, a canonical representation of the data element format/schema is produced (stage 310). For example, for the name “Bob Smith” the canonical representation may be “string, string” rather than “bob, smith”. As an additional example, the data may include the following XML schema:

```
<?xml version=“1.0” encoding<“UTF-8”?>
<xsd,schema xmlns:xsd=http://www.w3.org/2001/XM Schema
            targetNamespace=http://www.sun.com/xml/datastore
            xmlns=http://www.sun.com/xml/datastire
            elementFormDefault=“qualified”>
<xsd:complexType name=“MyType”>
    <xsd:sequence>
        <xsd:element
name=“MyString”type=“xsd:string”minOccurs=“0”maxOccurs=1”/>
        <xsd:element name=“MyInt” type=“xsd:integer” minOccurs=“0”
maxOccurs=“1”/>
        <xsd:element
name=“MyBinary”type=“xsd:base64Binary”minOccurs=“0”maxOccurs=”
        <xsd:element
name=“MyBoolean”type=“xsd:Boolean”minOccur=“0”maxOccurs=“1”/<
    </xsd: sequence>
        </xsd:complexType>
        <xsd:element name=“data”type=“dataType”/>
</xsd:schema>
```

Applying X.694 may convert this XML schema to the following ASN.1 PER schema:

```
MyDataDefinition DEFINITIONS AUTOMATIC TAGS
BEGIN
MyType ::= SEQUENCE
    MyString UTF8Strng,
    MyInt XSD.Int OPTIONAL
    MyBinary OCTET String,
    MyBoolean BOOLEAN OPTIONAL
END
```

When an instance of “MyType”, for example, is serialized using ASN.1 PER, it may consist of a sequence of two initial bits indicating the presence or omission of each of the contained optional fields (one bit per optional field) followed by serializations of each of the fields that are present in the order given. The names of the type and its fields are not significant with respect to the serialization, but the data type of the fields and their optionality are.

After producing the canonical representation of the data element, subroutine 210 hashes that representation to produce the unique identifier (stage 315). The unique identifier format may be governed by the algorithm used to compute it. For example, one algorithm may produce a fixed size unique identifier of 16 bytes. For example, in the unique identifier may be a fixed size. An XML based representation, “MyType”, for example, can be represented as the following canonical form:

```
<sequence>
    <simpleType>utf8string</simpleType>
    <optional><simpleType>integer</simpleType></optional>
    <simpleType>octet string</simpleType>
    <optional><simpleType>Boolean</simpleType></optional>
</sequence>
```

More complex data structures may be represented by recursing (or referring back to itself) the structure while applying the mapping rules described below. Recursive data structures describe the handling of self-referential data structures. Consider the following schema type:

```
<xs:complexType name=“subcode”>
    <xs:sequence>
        <xs:element name=“Value”
            type=“xs:int”/>
        <xs:element name=“Subcode”
            type=“tns:subcode”
            minOccurs=“O”/>
        </xs:sequence>
    </xs:complexType>
```

Applying X.694 converts this schema type to the following ASN.1 schema fragment:

```
subcode ::=SEQUENCE {
    Value INTEGER.
    Subcode subcode OPTIONAL
```

When a datatype contains an instance of itself, as shown above, the recursive approach may lead to an infinite inclusion loop. In such cases, the first instance of the datatype may be mapped as described above, but the second instance may be mapped to a special element that indicates the recursion. This captures the contents of the structure without infinite recursion. For example, the above ASN.1 schema fragment example may be mapped to:

```
<sequence>
    <simpleType>integer</simpleType>
    <optional><recursion>subcode</recursion></optional>
    </sequence>
```

After producing the unique identifier, subroutine 210 returns (stage 320).

The following subsections describe, the mapping from each of the ASN.1 primitives to the canonical XML form.

BOOLEAN

An unconstrained ASN.1 BOOLEAN is mapped to:

<simpleType>Boolean</simpleType>

A constrained ASN.1 BOOLEAN is mapped to an empty string.

FINNEGAN INTEGER

An unconstrained ASN.1 INTEGER is mapped to:

<simpleType>integer</simpleType>

A constrained ASN.1 INTEGER is mapped to:

```
<constraint>
    <min>limit</min>
    <max>limit</max>
    <simpleType>integer>integer</simpleType>
</constraint>
```

This min and max elements are both optional. If either is unconstrained, then the corresponding element is omitted.

For example:

Range ::=INTEGER (1.56)

would be mapped to:

```
<constraint>
    <mini>1</min>
    <max>56</max>
<simpleType>integer</simpleType>
</constraint>
```

UTF8String

An ASN.1 UTF8String is mapped to:

<simpleType>UTF8String</simpleType>

Sing constrained are ignored.

ENUMERATED

An ASN.1 ENUMERATED is mapped to:

```
<constraint>
    <size>limit</size>
    <simpleType>enumerated</simpleType>
</constraint>
```

The size element is required and provides the number of values in the enumeration.

OCTET STRING

A unconstrained ASN.1 OCTET STRING is mapped to:

<simpleType>octet string</simpleType>

A fixed length ASN.1 OCTET STRING under 8 k in length is mapped t:

```
<constraint>
    <size>limit</size>
    <simpleType>octet string</simpleType>
</constraint>
```

The size element is required and provides the number of bytes in the OCTET STRING.

SEQUENCE

An ASN.1 SEQUENCE is mapped to:

<sequence> . . . </sequence>

where “ . . . ” represents the content of the sequence.

SEQUENCE OF

An unconstrained ASN.1 SEQUENCE OF is mapped to:

<sequenceOf> . . . </sequenceOf>

A fixed length ASN.1 SEQUENCE OF is mapped to:

```
<constraint>
    <size>limit</size>
    <sequenceOf>...</sequenceOf>
</constraint>
```

The size element is required and provides the number of entries in the SEQUENCE OF.

CHOICE

An ASN.1 CHOICE is mapped to:

<choice> . . . </choice>

where “ . . . ” represents the content of the choice. Order is significant and must follow the same order as specified in the ASN.1 schema.

OPTIONAL

An ASN.1 OPTIONAL is mapped to:

<optional> . . . </optional>

where “ . . . ” represents the optional content.

A system consistent with this invention can be constructed in whole or in part from special purpose hardware or a general purpose computer system, or any combination thereof. Any portion of such a system may be controlled by a suitable program. Any program may, in whole or in part, be stored on the system or be provided in to the system over a network or other mechanism for transferring information. In addition, the system may be operated and/or otherwise controlled by means of information provided by an operator using operator input elements (not shown) that may be connected directly to the system or that may transfer the information to the system over a network or otherwise.

The foregoing description of specific embodiments do not limit the scope of invention, which the attached claims define. Various variations and modifications may be made to the embodiments, and systems may be implemented in a variety of ways consistent with the following claims.

What is claimed is:

1. A method for communicating a data element in a way that does not identify the format of the element, comprising:
creating a unique identifier specifying the format of the data element;
inserting the unique identifier as part of the data element; and
transmitting the data element and unique identifier.

2. The method of claim 1, wherein creating the unique identifier further comprises producing a canonical representation.

3. The method of claim 2, wherein creating the unique identifier further comprises hashing the canonical representation to produce the unique identifier.

4. The method of claim 3, wherein creating the unique identifier further includes creating the unique identifier with a fixed size.

5. The method of claim 3, wherein creating the unique identifier further includes creating the unique identifier with a fixed size of sixteen bytes.

6. The method of claim 1, wherein creating the unique identifier further includes creating the unique identifier with an indication of a recursion.

7. The method of claim 1, wherein creating the unique identifier further includes determining whether the expected form includes a structure or a type of data in the data element.

8. The method of claim 1, wherein transmitting the data element includes transmitting the data element through the Internet.

9. The method of claim 1, wherein transmitting the data element includes transmitting the data element in the ASN.1 PER standard format.

10. A method for communicating a data element in a way that does not identify the format of the element, comprising:
receiving the data element;
extracting a unique identifier that specifies the format of the data element; and
processing the data using the unique identifier.

11. The method of claim 10, wherein receiving the unique identifier further comprises receiving the unique identifier of a fixed size.

12. The method of claim 10, wherein receiving the unique identifier further comprises receiving the unique identifier with a fixed size of sixteen bytes.

13. The method of claim 10, wherein receiving the unique identifier further comprises receiving the unique identifier indicating a recursion.

14. The method of claim 10, wherein processing the unique identifier includes determining whether the expected form comprises a structure.

15. The method of claim 10, wherein processing the unique identifier includes determining whether the expected form comprises a type of data.

16. The method of claim 10, wherein processing the unique identifier includes:
creating a second identifier based on an expected format of the data element; and
comparing the unique identifier and the second identifier.

17. The method of claim 10, wherein receiving the data element includes receiving the data element in the ASN.1 PER standard format.

18. A system for communicating a data element in a way that does not identify the format of the element, comprising:
a component for creating a unique identifier specifying the format of the data element;
a component for inserting the unique identifier as part of the data element; and
a component for transmitting the data element and unique identifier.

19. The system of claim 18, wherein the component for creating the unique identifier is further configured for producing a canonical representation.

20. The system of claim 19, wherein the component for creating the unique identifier is further configured for hashing the canonical representation to produce the unique identifier.

21. The system of claim 20, wherein the component for creating the unique identifier is further configured for creating the unique identifier with a fixed size.

22. The system of claim 20, wherein the component for creating the unique identifier is further configured for creating the unique identifier with a fixed size of sixteen bytes.

23. The system of claim 18, wherein the component for creating the unique identifier is further configured for creating the unique identifier with an indication of a recursion.

24. The system of claim 18, wherein the component for creating the unique identifier is further configured for determining whether the expected form includes a structure or a type of data in the data element.

25. The system of claim 18, wherein the component for transmitting the data element is further configured for transmitting the data element through the Internet.

26. The system of claim 18, wherein the component for transmitting the data element is further configured for transmitting the data element in the ASN.1 PER standard format.

27. A system for communicating a data element in a way that does not identify the format of the element, comprising:
a component for receiving the data element;
a component for extracting a unique identifier that specifies the format of the data element; and
a component for processing the data using the unique identifier.

28. The system of claim 27, wherein the component for receiving the unique identifier is further configured for receiving the unique identifier of a fixed size.

29. The system of claim 27, wherein the component for receiving the unique identifier is further configured for receiving the unique identifier with a fixed size of sixteen bytes.

30. The system of claim 27, wherein the component for receiving the unique identifier is further configured for receiving the unique identifier indicating a recursion.

31. The system of claim 27, wherein the component for processing the unique identifier is further configured for determining whether the expected form comprises a structure.

32. The system of claim 27, wherein the component for processing the unique identifier is further configured for determining whether the expected form comprises a type of data.

33. The system of claim 27, wherein the component for processing the unique identifier is further configured for:
creating a second identifier based on an expected format of the data element; and
comparing the unique identifier and the second identifier.

34. The system of claim 27, wherein the component for receiving the data element is further configured for receiving the data element in the ASN.1 PER standard format.

35. A computer-readable medium on which is stored a set of instructions for communicating a data element in a way that does not identify the format of the element, which when executed perform stages comprising:
creating a unique identifier specifying the format of the data element;
inserting the unique identifier as part of the data element; and
transmitting the data element and unique identifier.

36. The computer-readable medium of claim 35, wherein creating the unique identifier further comprises producing a canonical representation.

37. The computer-readable medium of claim 36, wherein creating the unique identifier further comprises hashing the canonical representation to produce the unique identifier.

38. The computer-readable medium of claim 37, wherein creating the unique identifier further includes creating the unique identifier with a fixed size.

39. The computer-readable medium of claim 37, wherein creating the unique identifier further includes creating the unique identifier with a fixed size of sixteen bytes.

40. The computer-readable medium of claim 35, wherein creating the unique identifier further includes creating the unique identifier with an indication of a recursion.

41. The computer-readable medium of claim 35, wherein creating the unique identifier further includes determining whether the expected form includes a structure or a type of data in the data element.

42. The computer-readable medium of claim 35, wherein transmitting the data element includes transmitting the data element through the Internet.

43. The computer-readable medium of claim 35, wherein transmitting the data element includes transmitting the data element in the ASN.1 PER standard format.

44. A computer-readable medium on which is stored a set of instructions for communicating a data element in a way that does not identify the format of the element, which when executed perform stages comprising:
receiving the data element;
extracting a unique identifier that specifies the format of the data element; and
processing the data using the unique identifier.

45. The computer-readable medium of claim 44, wherein receiving the unique identifier further comprises receiving the unique identifier of a fixed size.

46. The computer-readable medium of claim 44, wherein receiving the unique identifier further comprises receiving the unique identifier with a fixed size of sixteen bytes.

47. The computer-readable medium of claim 44, wherein receiving the unique identifier further comprises receiving the unique identifier indicating a recursion.

48. The computer-readable medium of claim 44, wherein processing the unique identifier includes determining whether the expected form comprises a structure.

49. The computer-readable medium of claim 44, wherein processing the unique identifier includes determining whether the expected form comprises a type of data.

50. The computer-readable medium of claim 44, wherein processing the unique identifier includes:
creating a second identifier based on an expected format of the data element; and
comparing the unique identifier and the second identifier.

51. The computer-readable medium of claim 44, wherein receiving the data element includes receiving the data element in the ASN.1 PER standard format.
